(19) United States
(12) Patent Application Publication
(10) Pub. No.: US 2010/0241870 A1
(43) Pub. Date: Sep. 23, 2010

(54) CONTROL DEVICE, STORAGE DEVICE, DATA LEAKAGE PREVENTING METHOD

(75) Inventors: Tatsunori ITO, Ome-shi (JP); Kazuo NAKASHIMA, Yokohama-shi (JP); Nobuhiko ISATO, Kawasaki-shi (JP); Toshiyuki HAYAKAWA, Kawasaki-shi (JP)

Correspondence Address: KNOBBE MARTENS OLSON & BEAR LLP, 2040 MAIN STREET, FOURTEENTH FLOOR, IRVINE, CA, 92614, US

(73) Assignee: TOSHIBA STORAGE DEVICE CORPORATION, Tokyo (JP)

(21) Appl. No.: 12/728,135

(22) Filed: Mar. 19, 2010

(30) Foreign Application Priority Data
Mar. 19, 2009 (JP) 2009-068388

(51) Int. Cl. G06F 12/14; H04L 9/06

(52) U.S. Cl. 713/189; 380/44

(57) ABSTRACT

According to one embodiment, a control device controls a storage device configured to encrypt data based on an encryption key, store the data in a storage region, and decrypt the data stored in the storage region based on the encryption key. The control device includes an information generator and an encryption key generator. The information generator generates information as change information when the storage device is turned on. The change information is different from information used when the storage device is last turned on. The encryption key generator generates an encryption key based on the change information generated by the information generator.

### CROSS-REFERENCE TO RELATED APPLICATIONS

This application is based upon and claims the benefit of priority from Japanese Patent Application No. 2009-068388, filed on Mar. 19, 2009, the entire contents of which are incorporated herein by reference.

### BACKGROUND

1. Field

One embodiment of the invention relates to a security technology related to information recorded on a storage device.

2. Description of the Related Art

There have been storage devices that automatically encrypt data to be recorded for preventing information leakage. Such function of the storage devices is known as full disk encryption (FDE). In the storage device with the FDE, an encryption key is generated based on a specified password, and the encrypted data can be decrypted when the password is input to the storage device.

For example, Japanese Patent Application Publication (KOKAI) No. 2004-341768 discloses a conventional technology for disabling restoration of data stored in a magnetic disk device by changing an encryption key for encryption of the data when the magnetic disk device is discarded.

With the conventional technology, if the storage device with the FDE is stolen, encrypted data may be decrypted by a third person due to password attack or password leakage since the encryption key is generated based on the password, and the data to be kept confidential may be leaked.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary block diagram of a hardware configuration of a magnetic disk device according to a first embodiment of the invention;

FIG. 2 is an exemplary functional block diagram of the magnetic disk device in the first embodiment;

FIG. 3 is an exemplary flowchart of the process of encryption key generation in the first embodiment;

FIG. 4 is an exemplary functional block diagram of a magnetic disk device according to a second embodiment of the invention;

FIG. 5 is an exemplary view of a storage region of the magnetic disk device in the second embodiment;

FIG. 6 is an exemplary view of setting information of the magnetic disk device in the second embodiment;

FIG. 7 is an exemplary flowchart of the process of encryption key generation in the second embodiment;

FIG. 8 is an exemplary view of a storage region of a magnetic disk device according to a third embodiment of the invention;

FIG. 9 is an exemplary functional block diagram of the magnetic disk device in the third embodiment; and

FIG. 10 is an exemplary flowchart of the process of encryption key generation in the third embodiment.

### DETAILED DESCRIPTION

Various embodiments according to the invention will be described hereinafter with reference to the accompanying drawings. In general, according to one embodiment of the invention, a control device controls a storage device configured to encrypt data based on an encryption key, store the data in a storage region, and decrypt the data stored in the storage region based on the encryption key. The control device comprises an information generator and an encryption key generator. The information generator is configured to generate information as change information when the storage device is turned on. The change information is different from information used when the storage device is last turned on. The encryption key generator is configured to generate an encryption key based on the change information generated by the information generator.

According to another embodiment of the invention, a storage device encrypts data based on an encryption key, stores the data in a storage region, and decrypts the data stored in the storage region based on the encryption key. The storage device comprises an information generator and an encryption key generator. The information generator is configured to generate information as change information when the storage device is turned on. The change information is different from information used when the storage device is last turned on. The encryption key generator is configured to generate an encryption key based on the change information generated by the information generator.

According to still another embodiment of the invention, there is provided a data leakage preventing method applied to a storage device configured to encrypt data based on an encryption key, store the data in a storage region, and decrypt the data stored in the storage region based on the encryption key. The data leakage preventing method comprises: an information generator generating information as change information when the storage device is turned on, the change information being different from information used when the storage device is last turned on; and an encryption key generator generating an encryption key based on the change information generated by the information generator.

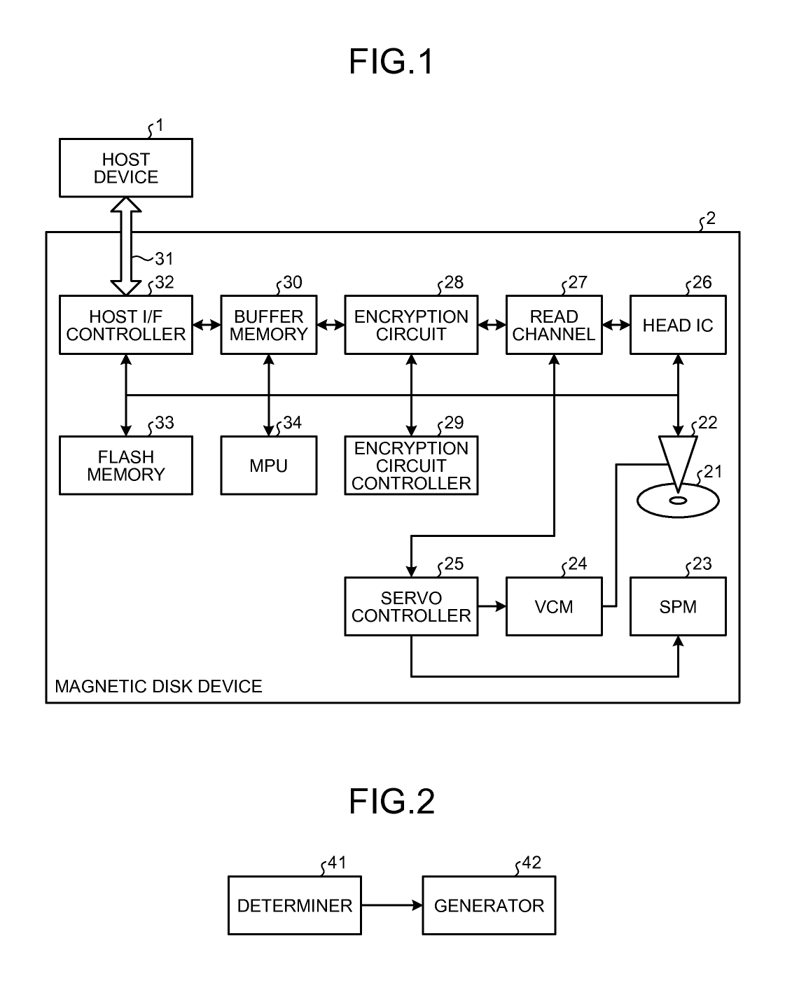

First, a configuration of a magnetic disk device 2 according to a first embodiment will be described. FIG. 1 illustrates a hardware configuration of the magnetic disk device 2.

As illustrated in FIG. 1, the magnetic disk device 2 (storage device) of the first embodiment is connected to a host device 1 as an upper device, and comprises a disk medium 21, a head 22, a spindle motor (SPM) 23, a voice-coil motor (VCM) 24, a servo controller 25, a head IC 26, a read channel 27, an encryption circuit 28, an encryption circuit controller 29, a buffer memory 30, a host Interface (I/F) 31, a host I/F controller 32, a flash memory 33, and a micro processing unit (MPU) 34.

The disk medium 21 is a storage medium for recording data as a signal. The head 22 writes a signal to the disk medium 21, and reads the signal written to the disk medium 21. The SPM 23 rotationally drives the disk medium 21. The VCM 24 drives the head 22. The servo controller 25 controls the SPM 23 and the VCM 24. The head IC 26 amplifies a signal to be written to the disk medium 21 by the head 22, and also a signal read from the disk medium 21. The read channel 27 converts data to be written to the disk medium 21 to a signal, and converts a signal read from the disk medium 21 to data. The encryption circuit 28 encrypts data to be written to the disk medium 21, and decrypts data read from the disk medium 21. The encryption circuit controller 29 controls the encryption circuit 28. The buffer memory 30 temporarily stores data to be written to the disk medium 21, and data read from the disk medium 21. The host I/F 31 contributes to communication related to transmission and receipt of data and commands between the host device 1 and the magnetic disk device 2. The host I/F controller 32 controls communication through the host I/F 31. The flash memory 33 is a nonvolatile memory for storing a program executed by the MPU 34, settings related to processing, and the like. The MPU 34 controls the overall operation of the magnetic disk device 2.

The magnetic disk device 2 receives a password, which is input by a user and authenticated by the host device 1, through the host I/F 31, and generates an encryption key based on the received password.

A functional configuration of the magnetic disk device 2 of the first embodiment will now be described. FIG. 2 illustrates the functional configuration of the magnetic disk device 2.

As illustrated in FIG. 2, the magnetic disk device 2 of the first embodiment comprises a determiner 41 and a generator 42 as functional modules. The determiner 41 determines matters related to processing. The generator 42 generates an encryption key to be used for encryption and decryption of data by the encryption circuit 28 based on the password (authentication information) authenticated by the host device 1. Each of these functional modules may be implemented by the MPU 34.

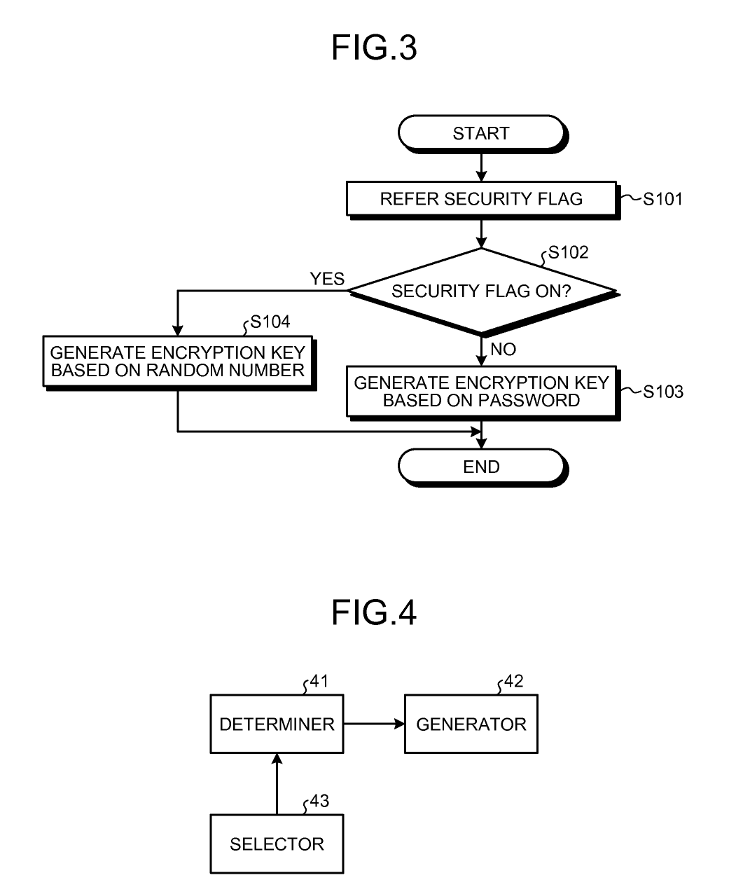

The process of the encryption key generation according to the first embodiment will now be described. FIG. 3 illustrates the process of the encryption key generation.

As illustrated in FIG. 3, the determiner 41 first refers to a security flag (setting information) stored in the flash memory 33 as a setting (S101), and determines whether the security flag is ON (S102). The security flag may be set ON or OFF by a user through the host device 1 and the like. The security flag set ON indicates that the encryption key is to be generated based on a random number, while set OFF indicates that the encryption key is to be generated based on the password.

If the security flag is not ON (NO at S102), the generator 42 generates an encryption key based on the password authenticated by the host device 1 (S103).

If the security flag is ON (YES at S102), the generator 42 generates a random number (change information), and generates an encryption key based on the random number (S104). The information used as a base in generation of an encryption key is not limited to a random number and may be any information other than the information (e.g., password) that has been used as a base in generation of an encryption key when the power is last turned on.

The encryption key thus generated based on the password or the random number is used by the encryption circuit 28 to encrypt data to be written and to decrypt data read. As described above, if the security flag is ON, an encryption key is generated based on the random number when the magnetic disk device 2 is activated. Therefore, the data that is already written is not correctly decrypted by the encryption circuit 28 since the data has been encrypted using the encryption key based on the password. Since information to be used as abase at the generation of the encryption key is changed when the power is turned on again as described above, when the magnetic disk device 2 is stolen, for example, the data can be prevented from being read by an entity who has stolen the magnetic disk device 2.

In the first embodiment, the security flag is not essential as long as the encryption key is generated using information different from the information, which has been used when the power is last turned on, triggered by turning ON of the magnetic disk device 2. For example, the encryption key may be generated based on a different random number each time the power is turned on. Since the power is kept ON through the time of the operation when the magnetic disk device 2 is used in a large-scale system, data leakage of the magnetic disk device 2 can be prevented by thus changing the encryption key when the power is turned on again.

A second embodiment differs from the first embodiment in that whether the encryption key is to be changed is set for each of a plurality of regions of the storage region of the magnetic disk device 2. A configuration and operation different from the first embodiment will be described below.

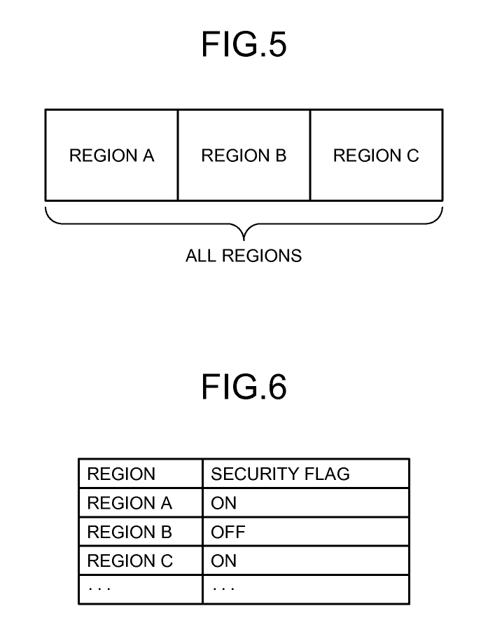

First, a functional configuration of the magnetic disk device different from the first embodiment will be described. FIG. 4 illustrates the functional configuration of the magnetic disk device 2 of the second embodiment. FIG. 5 illustrates the storage region of the magnetic disk device 2 of the second embodiment. FIG. 6 illustrates setting information of the magnetic disk device 2 of the second embodiment.

As illustrated in FIG. 4, differently from the first embodiment, the magnetic disk device 2 of the second embodiment comprises a selector 43 in addition to the determiner 41 and the generator 42. The selector 43 selects each of the regions illustrated in FIG. 5. The determiner 41 determines whether the encryption key is to be changed for each region referring to the setting information illustrated in FIG. 6. In the setting information, the regions are respectively associated with security flags, and whether the encryption key is to be changed is determined based on a security flag associated with each of the regions. The setting information is stored in the flash memory 33.

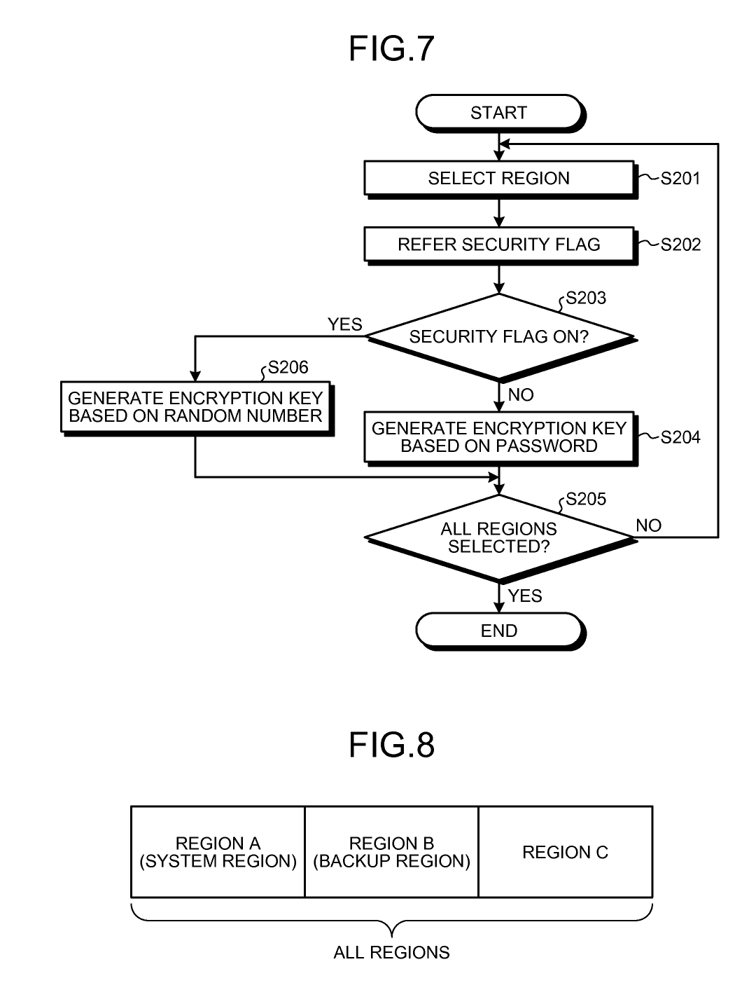

The process of the encryption key generation according to the second embodiment will now be described. FIG. 7 illustrates the process of the encryption key generation according to the second embodiment.

As illustrated in FIG. 7, when the magnetic disk device 2 is turned on, the selector 43 first selects predetermined one of the regions of the storage region of the magnetic disk device 2 (S201). The determiner 41 refers to the setting information (S202) and determines whether the security flag associated with the region selected by the selector 43 is ON (S203).

If the security flag associated with the selected region is not ON (NO at S203), the generator 42 generates an encryption key based on the authenticated password (S204). The determiner 41 then determines whether all the regions of the storage region of the magnetic disk device 2 have been selected (S205).

If all the regions have been selected (YES at S205), the encryption key generation ends.

If all the regions have not been selected (NO at S205), the selector 43 selects a predetermined region (S201) from the non-selected regions of the regions in the storage region of the magnetic disk device 2.

If the security flag associated with the selected region is ON (YES at S203), the generator 42 generates a random number, and generates an encryption key based on the random number (S206). Then, the determiner 41 again determines whether all the regions in the storage region of the magnetic disk device 2 have been selected (S205).

By changing an encryption key depending on setting information for each of the regions as described above, data only in a region where the data to be kept confidential is written can be prevented from being read.

A third embodiment is similar to the second embodiment in that an encryption key is generated for each region, but differs from the second embodiment in that an encryption key is changed for a region other than a backup region of the regions. A magnetic disk device according to the third embodiment will be described below.

First, a storage region of the magnetic disk device 2 of the third embodiment will now be described. FIG. 8 illustrates the storage region of the magnetic disk device 2 of the third embodiment.

As illustrated in FIG. 8, the storage region of the magnetic disk device 2 of the third embodiment comprises at least a system region and a backup region of the system region. An operating system (OS) is installed in the system region, and the data in the system region is copied to the backup region.

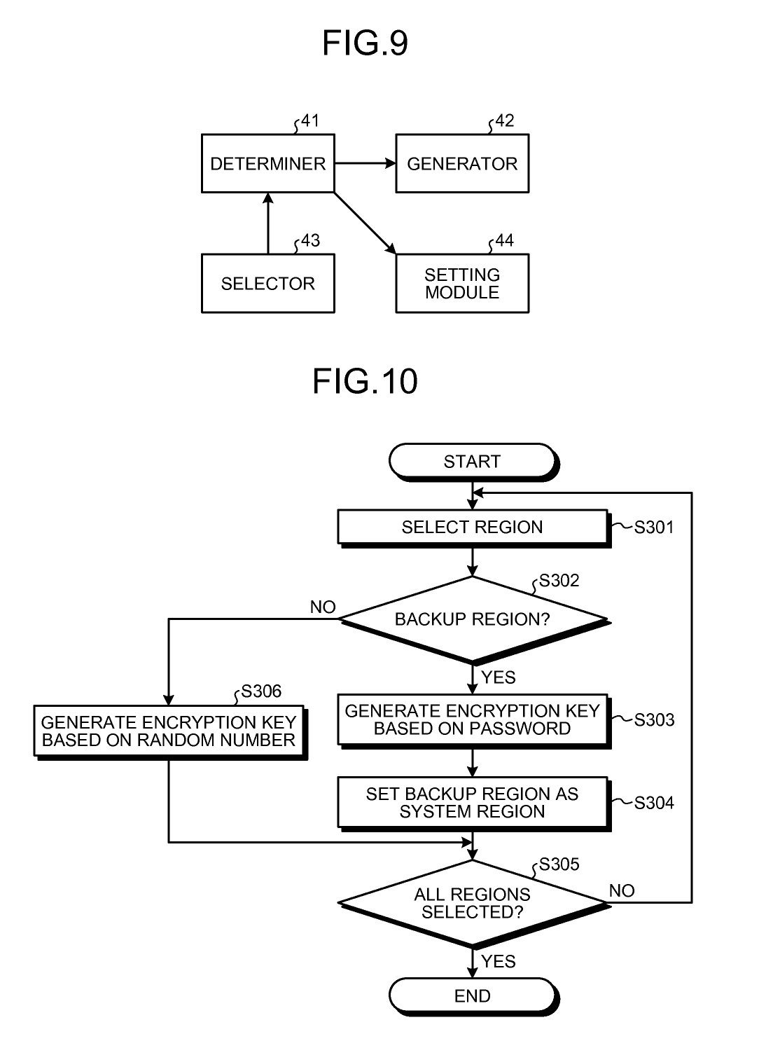

A functional configuration of the magnetic disk device 2 of the third embodiment will now be described. FIG. 9 illustrates the functional configuration of the magnetic disk device 2 of the third embodiment.

As illustrated in FIG. 9, differently from the second embodiment, the magnetic disk device 2 of the third embodiment comprises a setting module 44 in addition to the determiner 41, the generator 42, and the selector 43 as functional modules. The setting module 44 sets the backup region as the system region.

The operation of the magnetic disk device 2 of the third embodiment will now be described. FIG. 10 illustrates the process of the encryption key generation according to the third embodiment.

As illustrated in FIG. 10, when the magnetic disk device 2 is turned on, the selector 43 first selects predetermined one of the regions of the storage region of the magnetic disk device 2 (S301). The determiner 41 determines whether the region selected by the selector 43 is the backup region referring to the setting information (S302).

If the selected region is the backup region (YES at S302), the generator 42 generates an encryption key based on the authenticated password (S303). The setting module 44 then sets the backup region as the system region (S304). The determiner 41 determines whether all the regions in the storage region of the magnetic disk device 2 have been selected (S305).

If all the regions have been selected (YES at S305), the encryption key generation ends.

If all the regions have not been selected (NO at S305), the selector 43 selects a predetermined region (S301) from the non-selected regions of the regions in the storage region of the magnetic disk device 2.

If the selected region is not the backup region (NO at S302), the generator 42 generates a random number, and generates an encryption key based on the random number (S306). The determiner 41 then determines whether all the regions in the storage region of the magnetic disk device 2 have been selected (S305) again.

By thus generating an encryption key of the backup region based on the password and generating an encryption key of another region based on a random number, the host device 1 can execute the OS while preventing data leakage of the magnetic disk device 2. Each embodiment described above can be used in combination. While the magnetic disk device 2 has been described in the above embodiments, the embodiments is applicable to any storage device.

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A control device configured to control a storage device configured to encrypt data based on an encryption key, to store the data in a storage region, and to decrypt the data in the storage region based on the encryption key, the control device comprising:
an information generator configured to generate a base value when the storage device is turned on, wherein the generated base value is different substantially every time the storage device is turned on; and
an encryption key generator configured to generate an encryption key based on the base value.

2. The control device of claim 1, further comprising:
a referring module configured to refer to a setting associated with the storage region, the setting configured to indicate whether the information generator is to generate a base value when the storage device is turned on; and
a determination module configured to determine whether the value of the setting referred to by the referring module indicates that the base value is to be generated;
wherein
when the determination module determines that the setting' s value indicates that the base value is to be generated, the information generator generates a base value and the encryption key generator generates an encryption key for the storage region based at least on the base value.

3. The control device of claim 2, wherein, the encryption key generator is configured to generate an encryption key for the storage region based at least on authentication information authenticated by an upper device of the storage device when the determination module determines that the setting' s value indicates that the information generator should not generate a base value when the storage device is turned on.

4. The control device of claim 1, wherein the storage region comprises a plurality of storage regions including at least a system region and a backup region, and wherein the control device further comprises:
a selector configured to select one of the plurality of storage regions when the storage device is turned on and
a determiner configured to determine whether the selected storage region is the backup region,
wherein
when the determiner determines that the selected storage region selected is not the backup region, the information generator generates a base value, and the encryption key generator generates an encryption key based at least on the base value.

5. The control device of claim 4, further comprising a region setting module configured to designate the selected storage region as the system region when the determiner determines that the selected storage region is the backup region.

6. A storage device comprising:
one or more storage regions;
a value generator configured to generate a value, wherein the value generator generates a different value substantially every time it generates a value; and
an encryption key generator configured to generate an encryption key based on the value generated by the value generator.

7. The storage device of claim 6, further comprising:
a referring module configured to refer to a setting, wherein the setting is associated with a storage region and wherein the setting is in one of a plurality of states, the setting state indicating if the value generator is to generate a value; and
a determiner configured to determine whether the setting state indicates that a value is to be generated; wherein
the value generator is further configured to generate a value if the determiner determines that the setting state indicates that the value generator is to generate a value, and
the encryption key generator is configured to generate an encryption key for the storage region associated with the setting, wherein the encryption key is based at least on the generated value.

8. The storage device of claim 7, wherein,
the encryption key generator is configured to generate an encryption key for the storage region associated with the setting, said encryption key based at least on an authentication value authenticated by an upper device of the storage device, if the determiner determines that the setting state does not indicate that the value generator is to generate a value.

9. The storage device of claim 6, wherein the storage region of the storage device comprises a plurality of storage regions, said storage regions including at least a system region and a backup region, the control device further comprising:
a selector configured to select a one of the storage regions when the storage device is turned on; and
a determiner configured to determine whether the selected storage region is the backup region, and wherein
the value generator is configured to generate a value if the determiner determines that the selected storage region is not the backup region, and
the encryption key generator is configured to generate an encryption key for the selected storage region, said encryption key based at least on the generated value.

10. The storage device of claim 9, further comprising a region setting module configured to designate the selected storage region as the system region if the determiner determines that the selected storage region is the backup region.

11. A method for preventing data leaks from a storage device, the method comprising:
generating a value when the storage device is turned on, the generated value different from substantially all value previously generated according to the method;
generating an encryption key based at least on the generated value;
encrypting data using the encryption key;
storing the encrypted data in a storage region associated with the storage device;
decrypting the stored encrypted data using the encryption key.

12. The method of claim 11, further comprising:
obtaining the value of a setting associated with a storage region associated with the storage device and
generating a value only if the setting information indicates that the value is to be generated;
wherein storing the encrypted data comprises storing the encrypted data in the storage region associated with the setting.

13. The method of claim 12, wherein generating an encryption key comprises generating an encryption key for the storage region
